(19) United States
(12) Patent Application Publication
(10) Pub. No.: US 2014/0082477 A1
(43) Pub. Date: Mar. 20, 2014

(54) COMPOUND MACHINE AND SYSTEM

(71) Applicants: Toshiba Tec Kabushiki Kaisha, Tokyo (JP); Kabushiki Kaisha Toshiba, Tokyo (JP)

(72) Inventors: Yusuke Hamada, Shizuoka-ken (JP); Kazuhiro Ogura, Kanagawa-ken (JP)

(73) Assignees: Toshiba Tec Kabushiki Kaisha, Tokyo (JP); Kabushiki Kaisha Toshiba, Tokyo (JP)

(21) Appl. No.: 13/955,441

(22) Filed: Jul. 31, 2013

(30) Foreign Application Priority Data
Sep. 19, 2012 (JP) 2012-205783

(51) Int. Cl. G06F 17/22

(52) U.S. Cl. CPC G06F 17/2247
USPC 715/234

(57) ABSTRACT

According to an embodiment, a compound machine comprises: a function execution section configured to execute a plurality of functions; an operation panel configured to include a window display screen; a storage section of a URL of a server apparatus; an imparting section configured to impart an object with a property or a method associated with more than one function in the plurality of functions to a window object from a browser which accesses the URL, creates a page in the window by the interpreting of a content, and outputs an action command to the function execution section by the input of an operation command to the page; and a control section configured to enable the function execution section to execute a specific action by a script of the window object imparted the execution function of the registered object.

### CROSS-REFERENCE TO RELATED APPLICATION

This application is based upon and claims the benefit of priority from Japanese Patent Application No. 2012-205783, filed Sep. 19, 2012, the entire contents of which are incorporated herein by reference.

### FIELD

Embodiments described herein relate to a compound machine, a system and a method.

### BACKGROUND

In a compound machine installed with a browser, a screen is displayed on a control panel by the execution of the file of a html (hyper text mark-up language) text received from a Web server in the browser and a script in the file. The browser displays a Web page on the screen, and displays a dynamic message or an alert in the page by the script.

Conventionally, an information processing apparatus (For example, see Japanese Unexamined Patent Application Publication No. 2012-19508) executing the function of the compound machine according to a request from the Web server is known. In the situation that the Web server is accessed by the browser carried on the compound machine and the function of the compound machine is executed from an operation screen on the Web page, the unique script describing various kinds of processing for the compound machine needs to be predefined.

### BRIEF DESCRIPTION OF THE DRAWINGS

FIG. 1 is a configuration diagram of a system according to an embodiment;

FIG. 2 is a diagram of an example of the list of a plurality of objects including a window object used in the system according to the embodiment;

FIG. 3 is a diagram illustrating a sequence of a method for executing the function of a compound machine according to the embodiment;

FIG. 4 is a diagram illustrating a sequence of a first action of the compound machine according to the embodiment;

FIG. 5 is a diagram illustrating a sequence of a second action of the compound machine according to the embodiment.

### DETAILED DESCRIPTION

In accordance with an embodiment, a compound machine comprises: a function execution section executing a plurality of functions including browsing; an operation panel accepting an operation input to the function execution section and having a screen displaying a window; a storage section of a URL (uniform resource locator) of a server apparatus, which provides a content including a script operating a window object displaying a display element of the window in the screen on the operation panel; an imparting section imparting an object having a property or a method associated with more than one function in the plurality of functions to the window object from a browser which accesses the URL of the storage section, creates a page in the window by the interpreting of the content, and outputs an action command for the function execution section by the input of an operation command to the page; and a control section enabling the function execution section to execute a specific action by the script of the window object imparted the execution function of the object registered by the imparting section.

In addition, in accordance with another embodiment, a system comprising: a server apparatus configured to provide a content including a script for operating a window object displaying the display element of a window; and a compound machine, including: a function execution section configured to execute a plurality of functions including the browsing of the content of the server apparatus; an operation panel configured to accept an operation input to the function execution section and have a screen displaying the window; a storage section configured to store a URL of the server apparatus designated by the operation panel; an imparting section configured to impart an object with a property or a method associated with more than one function in the plurality of functions to the window object from the browser which accesses the URL of the storage section, creates a page in the window by the interpreting of the content, and outputs an action command for the function execution section by the input of an operation command to the page; and a control section configured to enable the function execution section to execute a specific action by the script of the window object of the execution function of the object registered by the imparting section.

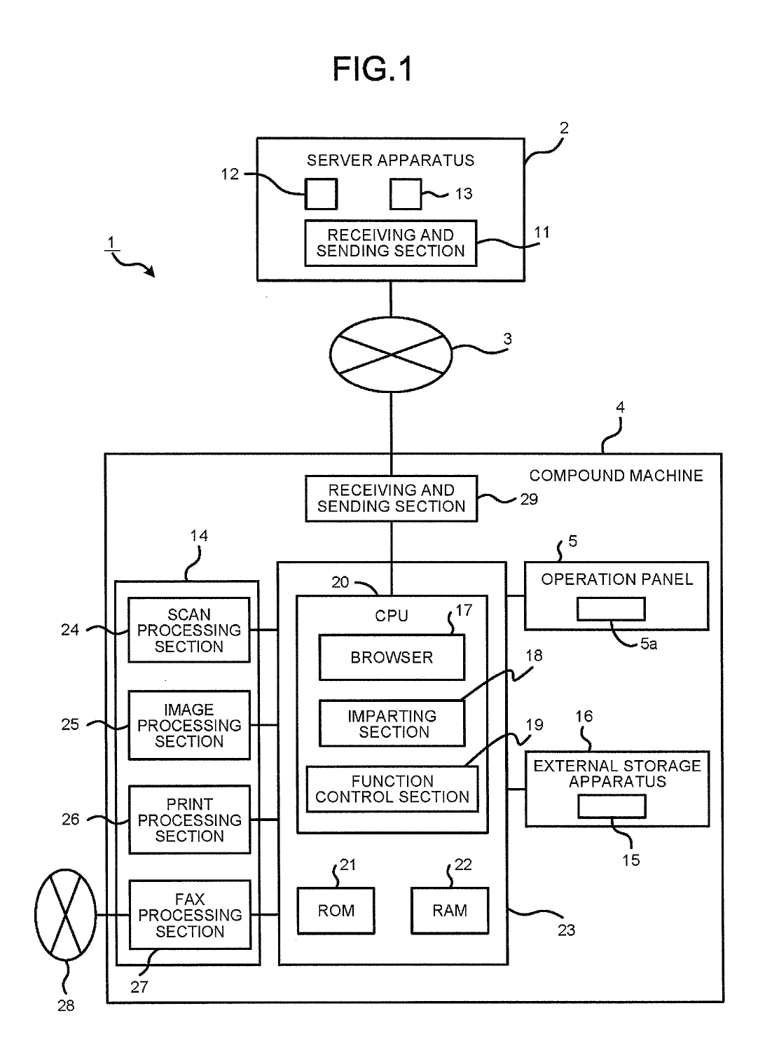

Hereinafter, the compound machine and the system according to the embodiment are described with reference to FIG. 1 to FIG. 5. In addition, a same position is marked with a same symbol in each figure, and repeated descriptions are omitted.

FIG. 1 is a configuration diagram of the system according to one embodiment. The system 1 comprises: the server apparatus 2 providing the contents including the script operating the window object displaying the display element of the window on the screen; the compound machine 4 which is connected with the server apparatus 2 through a network 3 constructed by using an internet or a LAN (local area network) and executes the plurality of functions including the browsing, print, copy, scan and FAX reception and sending of a Web site which is provided by the server apparatus 2; and the operation panel 5 arranged in the compound machine 4 and operated by a user. The window refers to a graphic user interface displaying information, and has a rectangular area. The window object refers to the object displaying the window of the browser on the side of a client. The script refers to an execution program.

When the URL is accessed from the compound machine 4 through the browser displayed on the operation panel 5, the server apparatus 2 returns a tag and the like described by using a html text, a command file displaying a Web page on the screen of the operation panel 5, and the script having a code described by using a JavaScript (registered trademark) as a script language embedded in the command file.

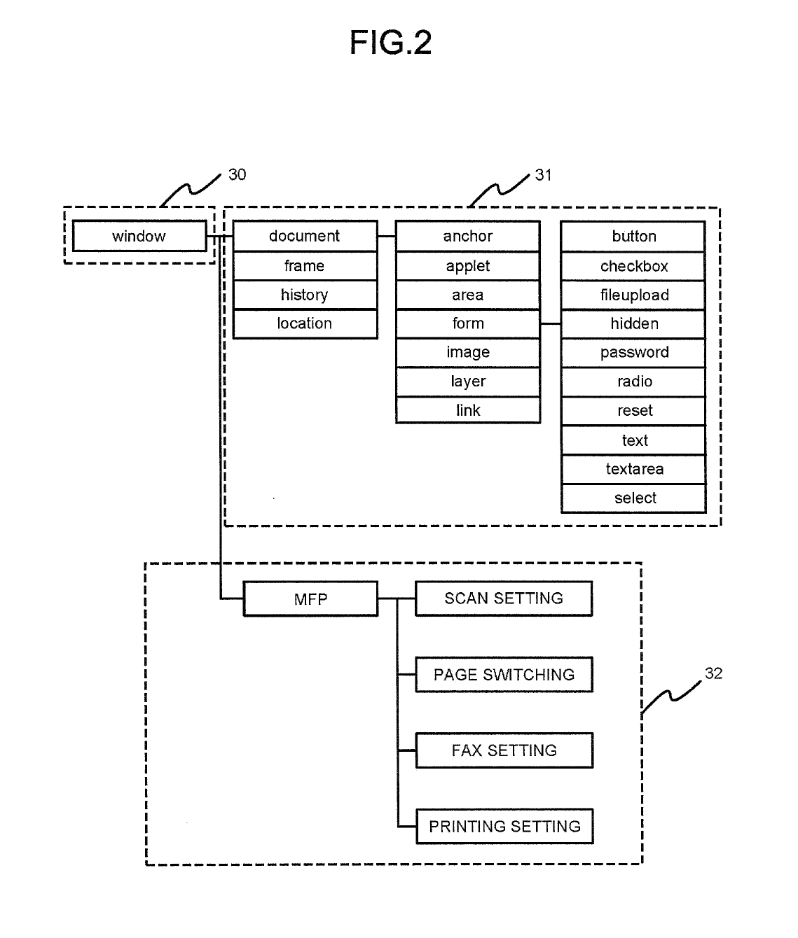

FIG. 2 is a diagram illustrating an example of the list of a plurality of objects including the window object. A relationship between the plurality of objects is illustrated in FIG. 2, and the script is described by the code (source code) having the relationship as a data structure. The code of the script has a parent window object 30 initially referred in an access to the Web site. The code is respectively described by using a plurality of sub-object groups 31 existing on the data structure under the window object 30 at the uppermost layer of a tree structure. The server apparatus 2 generates the window displayed on the screen of the operation panel 5 on the compound machine 4 by the script operating the window object 30. By executing the script by the compound machine 4, the server apparatus 2 depicts and operates the window to acquire the information related to the window displayed on the screen of the operation panel 5.

The server apparatus 2 previously stores the code of the unique object 32 defined by a user enabling the compound machine 4 to execute more than one functions. According to a request from the browser on the compound machine 4, the server apparatus 2 registers the additional object 32 to the list of an object reference under the window object 30, and adds the execution function of the additional object 32 in one of the functions realized by the original window object 30. The compound machine 4 enables a scanner and the like act according to the property and the method defined in these window object 30, object group 31 and additional object 32 by receiving and interpreting the script generated by the window object 30, the object group 31 and the additional object 32. The compound machine 4, previously executes the specific action including more than one or two functions in the plurality of functions, such as print execution, scan parameter setting and transition the function screen except the browser from the other side by the access to the known URL on the compound machine 4.

In FIG. 1, the server apparatus 2 is a computer device acting as a Web server, and comprises: a receiving and sending section 11 receiving and sending data with the network 3 with a determined procedure; and a storage section 12 for content data including the command file describing a character, the tag, a form and the like, an image or a dynamic image constituting the page together with these characters and the like, and a script code describing the content of the processing embedded in the command file. The storage section 12 previously stores the additional object 32 imparted according to the request from the compound machine 4 or the script code of the additional object 32. In addition, the server apparatus 2 comprises a Web server module 13 executing the script engine function of the code of the object assembled and added in the code of the original window object by interpreting and executing the script code. The Web server module 13 carries out the communication management based on a communication protocol as a server replying file data to the request. The Web server module 13 is in the state that a program is loaded in a memory and is executed by a processor.

In addition, the compound machine 4 comprises: a function execution section 14 executing the plurality of functions including the browsing of the content of the server apparatus 2; the operation panel 5 accepting the operation input to the function execution section 14 and having a screen 5a displaying the window; and an external storage apparatus 16 including a storage section 15 of the URL of the server apparatus 2, which is designated by the operation panel 5. In addition, the compound machine 4 comprises: a browser 17 outputting an action to the function execution section by accessing the URL of the storage section 15, creating the page in the window by the interpreting of the content, and by the input of the operation command to the page; and an imparting section 18 imparting the additional object 32 having the property or the method associated with more than any one of the plurality of functions to the original window object 30 from the browser 17. The compound machine 4 comprises: a function control section 19 (control section) interpreting the script of the window object imparted the execution function of the registered additional object 32 by the imparting section 18, so as to enable the function execution section 14 to execute the specific action; a controller 23 taking charge of the overall control of the compound machine 4; and a receiving and sending section 29 receiving and sending the data with the server apparatus 2 through the network 3.

The function execution section 14 carries out the actions of the execution command of the print, the setting of the parameter of the scan and the transition to the function screen except screen display by the browsing, and the FAX reception and sending, and the like. The function execution section 14 comprises: a scan processing section 24 controlling a four-row line sensor and a reduction optical system which are not shown in the figures and reading an original surface in an optical manner to generate image data; and an image processing section 25 designating such a print condition of the development or the correction of the data to be printed, a random multiplying power and the page number of each surface which are included in the image data from the scan processing section 24 or a print job. The function execution section 14 comprises: a conveyance system with a feedback conveyance path for duplex print, which draws out paper set in a paper cassette and conveys it; and a print processing section 26 forming and fixing a 3-color toner image on the surface of the conveyed paper. In addition, the function execution section 14 also comprises a FAX processing section 27 using a public network 28 to receive and send the image data in a facsimile specification.

In addition, the operation panel 5, for example, is a touch panel. The operation panel 5 comprises: a liquid crystal or organic EL (Electro Luminescence) display; a drive circuit arranged on the back side of the display and displaying the browser; and an input section detecting a touch position on a touched panel surface arranged on the screen 5a. The operation panel 5 acquires the Web site on the internet and a plurality of Web pages included in the Web site by a direct touch input. The operation panel 5 accepts the read setting and the printing setting of an original on a scan-oriented glass table and the input of a FAX number. For example, the operation panel 5 adjusts a read multiplying power and the brightness and the definition of a read image quality. As the condition of the original to be copied, the operation panel 5 designates a color or a monochrome, and a size such as A4 (ISO [international organization for standardization] A4) and the like. As the condition of the paper to be printed, the operation panel 5 designates the color or the monochrome, A3 or A4, duplex or simplex, horizontally-opened, 1 in 1, 2 in 1 or 4 in 1 and copy number.

The external storage apparatus 16 is a hard disk drive or a silicon disk drive with a large-capacity storage area, and moreover, has a storage area for constituting the storage section 15 in the storage area. Various applications such as an operating system, a device driver, communication control, the browsing, the interpreting and the execution of the script, and the like, are stored in the external storage apparatus 16.

The browser 17 has a function of analyzing and executing a plurality of properties and a plurality of methods included by the script code of the window object 30 and the object group 31 which are shown in FIG. 2. The browser 17 has a function of analyzing the property to the function execution section 14 and the method to the function execution section 14, which are included by the script code of the additional object 32, and enabling the function execution section 14 to act. The browser 17 enables more than two functions in the plurality of functions of the function execution section 14 to continuously act by a method for calling out the property returning the property value of the property of the window and the operation function of the window. When the plurality of functions in the specific actions are executed, the browser 17 transfers the parameter of function execution among the plurality of properties or the plurality of methods. Specifically, the browser 17 has the function of utilizing an http (Hyper Text Transport Protocol) to communicate with the server apparatus 2, the function of interpreting the code of a markup language and displaying the screen by the code, the script engine function of explaining and executing the script code, a user interface function such as the operation of the compound machine 4 or the setting input and the like of the function execution section 14, and the like.

The imparting section 18 sends the request of object impartation to the server apparatus 2 based on the operation to the operation panel 5 by the user. The imparting section 18 sends the request of such a content that the server apparatus 2 imparts the unique additional object 32 kept by the server apparatus 2 to the window object 30. The imparting section 18 requests the server apparatus 2 to register the additional object 32 to the list of the window object 30.

In addition, the function control section 19 in FIG. 1 enables the browser 17 to interpret and execute the code of the script described by the window object 30 sent from the server apparatus 2 after the additional object 32 is added and registered to the list of the window object 30 in the browser 17. The function control section 19 enables the function execution section 14 to execute the specific action through the controller 23 of the compound machine 4 by the execution of the script. Each function of the browser 17, the imparting section 18 and the function control section 19 is executed by a CPU (central processing unit) 20, a ROM (read only memory) 21 and a RAM (random access memory) 22. The controller 23 controls each action in the function execution section 14 by executing the control program and the application of the ROM 21 by the CPU 20. The receiving and sending section 29 is a communication interface section, and receives and sends a command with the receiving and sending section 11 on the side of the server apparatus 2.

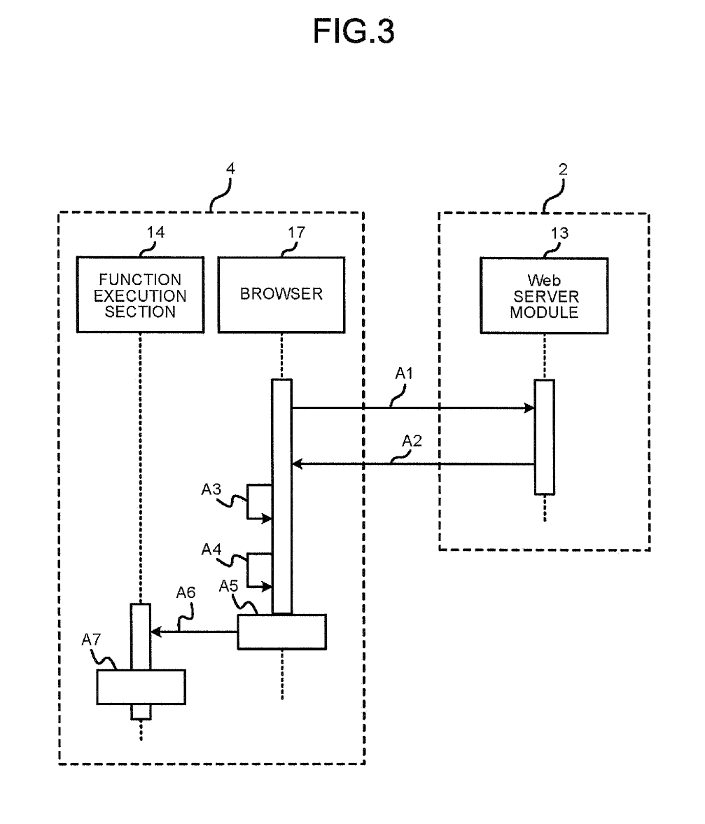

FIG. 3 is a diagram illustrating a sequence of a method for executing the function of the compound machine 4 in the system 1. The symbol which has been described denotes an element the same as the element indicated by these symbols. A lengthwise quadrangle denotes the program processing of continuing the exchange of the reception and the sending of more than one message after the sending of an initial message.

The system with configurations mentioned above in one embodiment is a system including the server apparatus 2 and the compound machine 4 holding the browser 17 displaying the Web page. Basic actions are illustrated in FIG. 3. First, in ACT A1, the browser 17 held by the compound machine 4 accesses the URL of the Web server module 13 and acquires the Web page. In ACT A2, the server apparatus 2 sends the script of the window object (hereinafter, called as object of the script language sometimes) of the JavaScript (registered trademark) to the compound machine 4. The browser 17 initializes the original window object 30 (ACT A3), and imparts the new additional object 32 to the window object 30 (ACT A4). In ACT A3, for example, the browser 17 carries out a reset action, so as to add the code of the script of the additional object 32 to the code of the original script, and read the added code anew. In ACT A4, the browser 17 can execute the function by the unique additional object 32 after the window object 30 of the script language is initialized.

In ACT A5, the browser 17 executes the method of the window object imparted the function. In ACT A6, the browser 17 sends an action request to the function execution section 14. In ACT A7, the compound machine 4 executes the function. The method, for example, can include the setting of the print condition to the print processing section 26, the setting of a print command and a copy condition, the setting of a scan parameter or a scan command to the scan processing section 24, the setting or the command to the browser 17 displaying the screen 5a of the operation panel 5, the command of the transition to the function screen except site display, the command of the FAX reception and sending, and the like.

The content of the method can also include more than one or two continuous combination of these functions. The compound machine 4 can carry out such a specific action of continuously executing to generate the image data by the scan processing section 24 and store the image data in the server apparatus 2. The compound machine 4 can continuously generate the image data and carry out the FAX sending on the image data, or generates the image data and prints the image data, or generates the image data, carries out the FAX sending to the image data together with printing the image data.

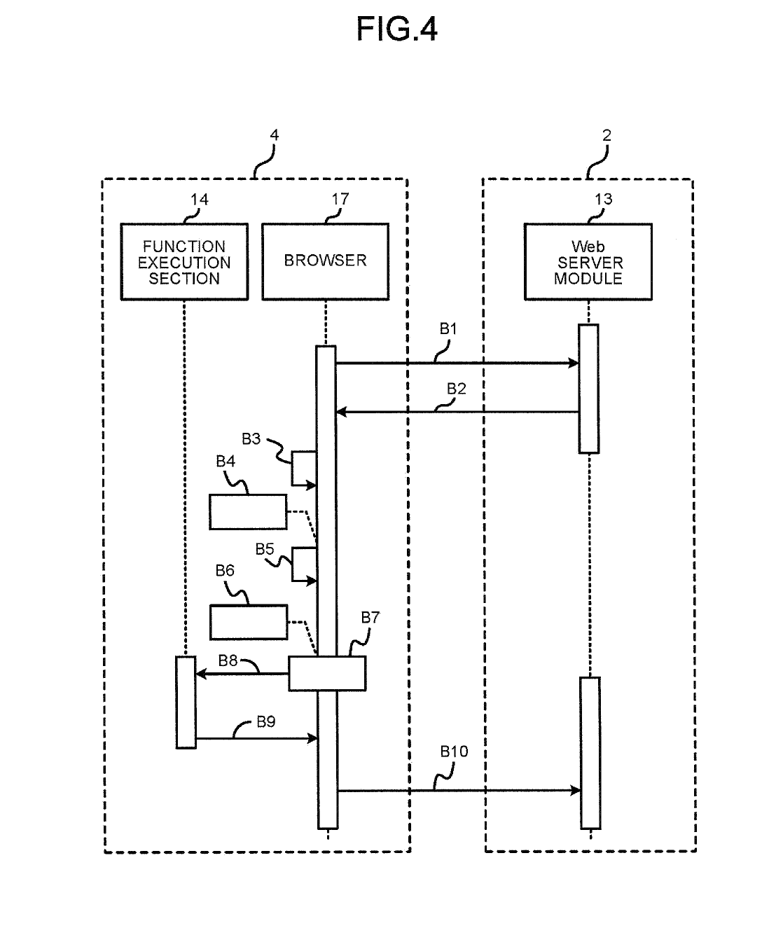

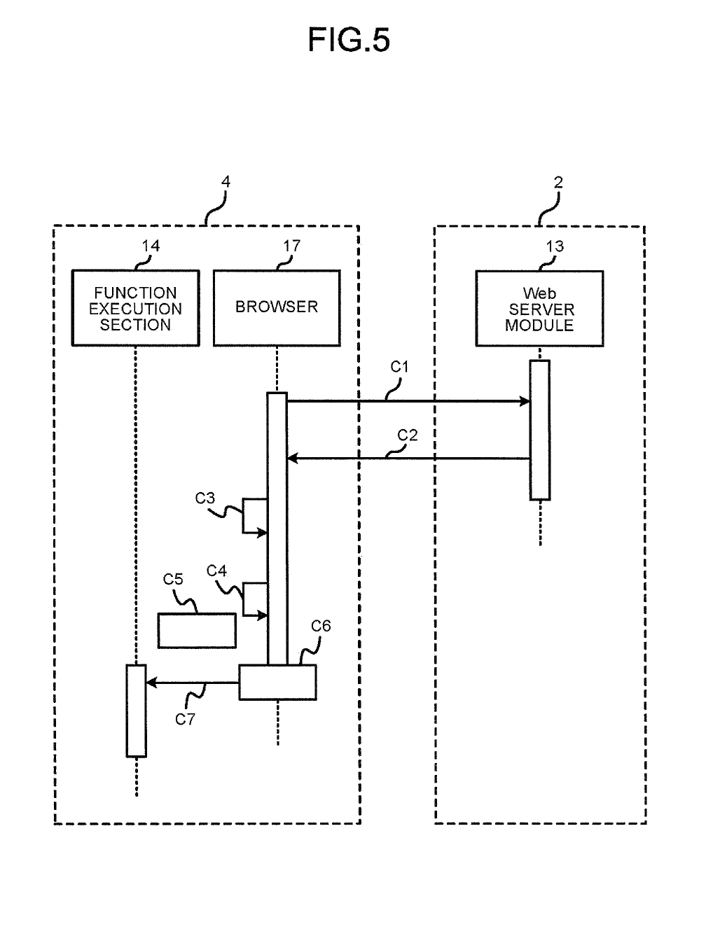

A flow of executing the function by the compound machine 4 is described hereinbefore. Hereinafter, the specific actions are described with reference to FIG. 4 and FIG. 5. Herein, the additional object 32 imparted by the server apparatus 2 is temporarily called as OBJECT.

As a first example, a sequence when the scan of the compound machine 4 is executed from the Web page is illustrated in FIG. 4. FIG. 4 is a diagram illustrating the sequence of the action uploading a file after the scan is executed. The symbol which has been described denotes the element the same as the element indicated by these symbols. For example, the action is assumed that the compound machine 4 sets the scan parameter, so as to carry out the scan of a paper file, and uploads a generated electronic file to the server apparatus 2 when the compound machine 4 uploads the file.

First, the compound machine 4 accesses the URL of the server apparatus 2 and acquires the Web page (ACT B1). The server apparatus 2 sends the script of the window object 30 of the JavaScript (registered trademark) to the compound machine 4 (ACT B2). The browser 17 initializes the window object 30 in ACT B3, and sets the scan parameter in ACT B4. Next, the browser imparts the _OBJECT_ with the method (for example, scan( ) which can execute the scan to the window object 30 (ACT B5). In ACT B6, for example, when pressing a scan button to the operation panel 5, an event which intends to upload the file to the Web page occurs. In ACT B7, at a timing when the event occurs, the browser 17 executes _OBJECT_.scan( ) by the script language. In ACT B7, the browser 17 submits the parameter for carrying out the setting of the scan to the argument of the scan( ). For example, if the parameter is in a JSON (JavaScript (registered trademark) object notation) form, the browser 17 sets the scan({format: “Slimpdf”, colorMode: “Monochrome”}).

When the _OBJECT_.scan( ) is executed in ACT B7, a scan request is conveyed to the function execution section 14 of the compound machine 4 from the browser 17 in ACT B8. By the setting mentioned above, the scan is executed. In ACT B8, the browser 17 notifies the controller 23 to drive the device drive of the scan processing section 24 to execute the scan, and electronic file data acquired by the scan are stored in the function execution section 14 or the external storage apparatus 16. A scan ending notification is notified from the function execution section 14 to the browser 17 in ACT B9. In ACT B10, the browser 17 sends the electronic file as a scan result generated after executing the scan to the Web server module 13 in a POST method and the like.

A general MFP prohibits such an action in the problem of security, but the compound machine 4 allows the execution carried out from the server apparatus 2 with the specific URL. The unique method of the additional object 32 is endowed, and by executing the unique method of the additional object 32 on the Web page, the request of the function is sent from the browser 17 to hardware configurating the function execution section 14 of the compound machine 4. Executing the function of the compound machine 4 from the Web page can be realized by a series of actions.

As a second example, an example of ending the browser 17 and transiting to the function page (copy screen or FAX screen and the like) of the compound machine 4 is illustrated in FIG. 5. FIG. 5 is a diagram illustrating the sequence of the action of transiting to the FAX screen. The symbol which has been described denotes the element the same as the element indicated by these symbols. For example, it is assumed that an action which writes the character in an application on the Web page and sends the data by the FAX processing section 27.

First, the browser 17 accesses the URL of the server apparatus 2 and acquires the Web page (ACT C1). The server apparatus 2 sends the script of the window object of the JavaScript (registered trademark) to the compound machine 4 (ACT C2). The browser 17 initializes the window object 30 (ACT C3). After the initialization, the browser 17 endows the OBJECT with the method (for example, moveToFAXPanel) which can transit to the FAX screen with the window object 30 (ACT C4).

In subsequent ACT C5, the browser 17 inputs a necessary item on the Web page. Afterwards, in ACT C6, at the stage when the preparation of the FAX sending is completed, the browser 17 executes _OBJECT_.moveToFAXPanel ( ). The function is executed by the Web page. If the argument is in the JSON form, for example, the browser 17 carries out the setting as moveToFAXPanel ({address: “0120-XXXX-XXXX”, userName: “user”, fileName: “document.pdf”}). In ACT C7, the argument passing is carried out by the method or the property, and the operation panel 5 displays the FAX screen on the window. It is transited from the usual screen to the FAX screen on the screen 5a. The user transiting to the FAX screen by passing the necessary parameter through argument when the FAX sending can carry out the FAX sending in the situation that a redundant operation is not carried out.

In conclusion, the browser 17 adds the unique additional object 32 holding the property or the method which can execute the function of the compound machine 4 in the window object 30 of the script language sent from the server apparatus 2 as a accessing destination, and executes the property or the method defined by the additional object 32, so that the specific function or action of the compound machine 4, such as the execution of the print, the setting of the scan parameter, the transit to the function screen except the browser 17, and the like, can be executed. In an existing hardware device, as each function can be executed by executing the defined property or method only, an application developer can enable the installation of the application to be carried out easily. The application developer of the server apparatus 2 can execute the given function without spending time on learning the format of the unique script and without carrying out the sending and receiving of the complicated message. As the function realized by the predefined additional object 32 is used, the compound machine 4 can utilize each function while maintaining the security. If the compound machine 4 allows the execution carried out from any URL, the security becomes deteriorative, and as the compound machine 4 limits the Web site to the specific URL, it can be used without any problem on the security. An assembly browser is provided.

In the embodiment mentioned above, the action of the compound machine 4 can be controlled to some degree by the server apparatus 2, and therefore, the system 1 can also limit the URL of the Web site endowed with the additional object 32 beforehand, and carries out the limitation with the manner of only endowing the Web site which can be trusted with the function of the additional object 32. For example, such a method for carrying out the limitation by using a host name or carrying out the limitation by using a consistent white list can be considered. By adopting such a configuration, the function of the compound machine 4 can be executed without a complicated procedure.

In the embodiment mentioned above, the compound machine 4 can connect a finisher to the output side of the print processing section 26, the function execution section 14 can also execute the function such as stapling or folding, sorting and the like by the command from the operation panel 5. The operation panel 5 can also designate the condition of such finishing processing of the stapling towards a left upper portion on a paper surface and the punching towards the blank central portion of the paper.

In the embodiment mentioned above, the markup language can also make use of other language. In the embodiment mentioned above, an example that the script code is embedded in the html text is described, but the URL storing the script code can be also directly designated without using the html text. The browser 17 can also access the URL and execute the script, and about an implementation example only carrying out and implementing such a modification, the superiority of the compound machine and the system of its embodiment is not damaged at all.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A compound machine, comprising:
a function execution section configured to execute a plurality of functions including browsing;
an operation panel configured to accept an operation input to the function execution section and have a screen displaying a window;
a storage section of a URL of a server apparatus configured to provide a content including a script for operating a window object displaying the display element of the window on the screen of the operation panel;
an imparting section configured to impart an object with a property or a method associated with more than one function in the plurality of functions to the window object from a browser which accesses the URL of the storage section, creates a page in the window by the interpreting of the content, and outputs an action command to the function execution section by the input of an operation command to the page; and
a control section configured to enable the function execution section to execute a specific action by the script of the window object imparted the execution function of the object registered by the imparting section.

2. The compound machine according to claim 1, wherein
the function execution section carries out at least one action of the execution command of print, the setting of the scan parameter, or the transit to a function screen except display screen by the browsing.

3. The compound machine according to claim 1, wherein
the browser enables more than two functions in the plurality of functions to continuously act by the property for returning the property value of the property of the window and the method for calling out the operation function of the window.

4. The compound machine according to claim 1, wherein
the browser transfers the parameter for executing the function among a plurality of properties or a plurality of methods.

5. A system comprising:
a server apparatus configured to provide a content including a script for operating a window object displaying the display element of a window; and
a compound machine, including:
a function execution section configured to execute a plurality of functions including the browsing of the content of the server apparatus;
an operation panel configured to accept an operation input to the function execution section and have a screen displaying the window;
a storage section configured to store a URL of the server apparatus designated by the operation panel;
an imparting section configured to impart an object with a property or a method associated with more than one function in the plurality of functions to the window object from the browser which accesses the URL of the storage section, creates a page in the window by the interpreting of the content, and outputs an action command for the function execution section by the input of an operation command to the page; and
a control section configured to enable the function execution section to execute a specific action by the script of the window object of the execution function of the object registered by the imparting section.

6. A script control method realized by a compound machine, comprising:
executing a plurality of functions including browsing by a function execution section;
accepting an operation input to the function execution section;
creating a page in a window by accessing a URL of a storage section of a server apparatus for providing the content including a script for operating a window object displaying the display element of the window on a screen of an operation panel with the screen displaying the window and interpreting of a content;
imparting an object with a property or a method associated with more than one function in the plurality of functions to the window object from the browser which outputs an action command to the function execution section by the input of an operation command to the page; and
enabling the function execution section to execute a specific action by the script of the window object imparting the execution function of the object registered.
